(19) United States
(12) Patent Application Publication
(10) Pub. No.: US 2025/0351159 A1
(43) Pub. Date: Nov. 13, 2025

(54) DETECTION AND RECEPTION OF A PHYSICAL BROADCAST CHANNEL

(71) Applicant: InterDigital Patent Holdings, Inc., Wilmington, DE (US)

(72) Inventors: Brian Martin, Farnham (GB); Virgil Comsa, Montreal (CA); Erdem Bala, East Meadow, NY (US); Moon-il Lee, Melville, NY (US); Janet A. Stern-Berkowitz, Little Neck, NY (US); Keiichi Kubota, Tokyo (JP)

(73) Assignee: InterDigital Patent Holdings, Inc., Wilmington, DE (US)

(21) Appl. No.: 18/860,383

(22) PCT Filed: Apr. 27, 2023
(86) PCT No.: PCT/US2023/020207

§ 371 Date: Oct. 25, 2024

Related U.S. Application Data
(60) Provisional application No. 63/335,466, filed on Apr. 27, 2022.

(51) Int. Cl. H04W 72/30; H04W 72/232

(52) U.S. Cl. CPC H04W 72/30; H04W 72/232

(57) ABSTRACT

Systems, methods, and instrumentalities are described herein for detection and reception of a physical broadcast channel (PBCH). A wireless transmit/receive unit (WTRU) may receive a first master information block (MIB). The WTRU may determine a first location or format for receiving a second MIB based on the contents of the first MIB. The contents of the first MIB may include first configuration information for a first control resource set (CORESET). The WTRU may receive the second MIB. The second MIB may be received using the first location or format. The WTRU may determine a second location or format associated with receiving a system information block (SIB) based on the contents of the second MIB. The contents of the second MIB may include second configuration information for a second CORESET. The WTRU may receive the SIB. The SIB may be received based on the second location or format.

### CROSS-REFERENCE TO RELATED APPLICATIONS

This application claims the benefit of Provisional U.S. Patent Application No. 63/335,466, filed Apr. 27, 2022, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for detection and reception of a physical broadcast channel (PBCH).

A wireless transmit/receive unit (WTRU) may receive a first master information block (MIB). The first MIB may be received via a physical broadcast channel (PBCH). The first MIB may include an indication that the second MIB is being transmitted. The WTRU may be a reduced capability WTRU. The WTRU may determine any of a first location or format for receiving a second MIB based on the contents of the first MIB. The WTRU may (e.g., may also) determine the first location or format for receiving a second MIB based on the WTRU being a reduced capability WTRU. The contents of the first MIB may include first configuration information for a first control resource set (CORESET). The WTRU may receive the second MIB. The second MIB may be received via a physical downlink control channel (PDCCH) downlink control information (DCI). The second MIB may be received using the first location or format. In examples, the first configuration information for the first CORESET may be used to determine the first location or format for receiving the second MIB.

The WTRU may determine any of a second location or format associated with receiving a system information block (SIB) based on the contents of the second MIB. The contents of the second MIB may include second configuration information for a second CORESET. The WTRU may receive the SIB. The SIB may be received based on the second location or format. In examples, the second configuration information for the second CORESET may be used to determine the second location or format for receiving a PDCCH DCI associated with receive the SIB. The second CORESET may be smaller than the first CORESET.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example configuration of frames and subframes.

FIG. 3 illustrates an example configuration of slots.

FIG. 4 illustrates an example of a synchronization signal block (SSB) time-frequency structure.

FIG. 5 illustrates an example of synchronization signal (SS) bursts and beam sweeping.

FIG. 6 illustrates an example of a WTRU that may detect an unsupported SSB/physical broadcast channel (PBCH).

FIG. 7 illustrates an example of reduced capability-PBCH detection and reception.

FIG. 8 illustrates an example of a reduced bandwidth, reduced capability-PBCH in the other half-frame compared to the legacy PBCH.

FIG. 9 illustrates a reduced bandwidth, reduced capability-PBCH in the same half-frame as the legacy PBCH.

FIG. 10 illustrates an example of a reduced capability-PBCH with the same bandwidth as a legacy PBCH.

FIG. 11 illustrates an example of reduced capability-reference signal (RS) symbol positioned in a reduced capability-PBCH.

### DETAILED DESCRIPTION

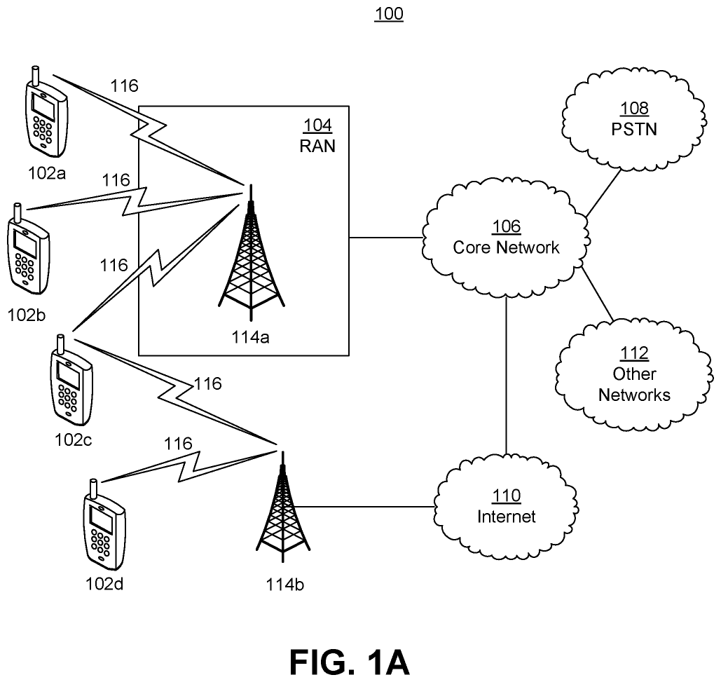

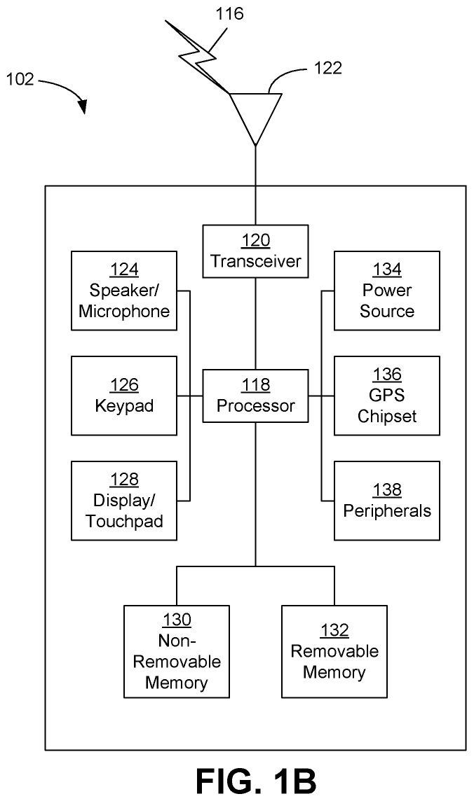

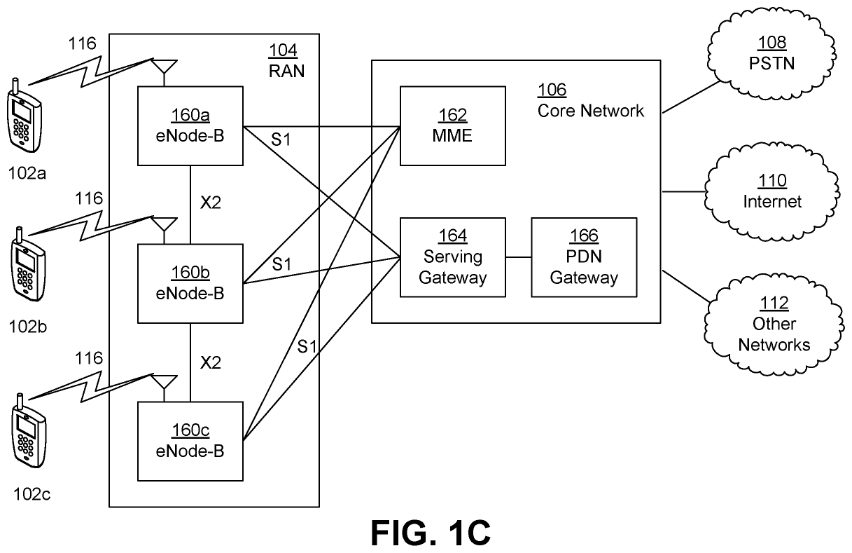

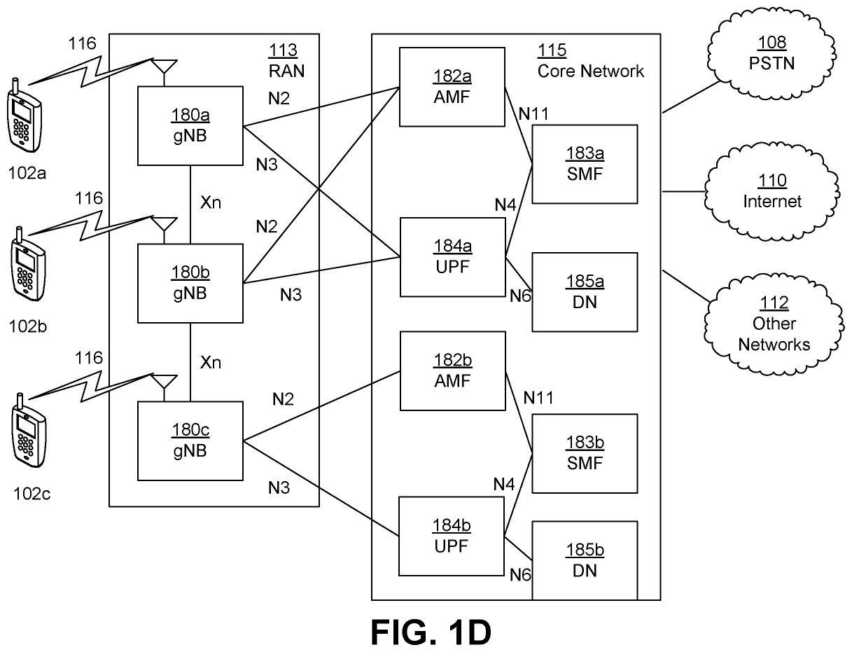

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Systems, methods, and instrumentalities are described herein for detection and reception of a physical broadcast channel (PBCH).

A wireless transmit/receive unit (WTRU) may receive a first master information block (MIB). The first MIB may be received via a physical broadcast channel (PBCH). The first MIB may include an indication that the second MIB is being transmitted. The WTRU may be a reduced capability WTRU. The WTRU may determine any of a first location or format for receiving a second MIB based on the contents of the first MIB. The WTRU may (e.g., may also) determine the first location or format for receiving a second MIB based on the WTRU being a reduced capability WTRU. The contents of the first MIB may include first configuration information for a first control resource set (CORESET). The WTRU may receive the second MIB. The second MIB may be received via a physical downlink control channel (PDCCH) downlink control information (DCI). The second MIB may be received using the first location or format. In examples, the first configuration information for the first CORESET may be used to determine the first location or format for receiving the second MIB.

The WTRU may determine any of a second location or format associated with receiving a system information block (SIB) based on the contents of the second MIB. The contents of the second MIB may include second configuration information for a second CORESET. The WTRU may receive the SIB. The SIB may be received based on the second location or format. In examples, the second configuration information for the second CORESET may be used to determine the second location or format for receiving a PDCCH DCI associated with receive the SIB. The second CORESET may be smaller than the first CORESET.

A network node may be configured to send a first MIB and a second MIB to a WTRU (e.g., a reduced capability WTRU). The first MIB may be sent via a PBCH. The first MIB may include first configuration information for a first CORESET. The second MIB may be sent via a PDCCH DCI. The second MIB may include second configuration information for a second CORESET. The second CORESET may be smaller than the first CORESET.

A wireless transmit/receive unit (WTRU) may determine whether a PBCH configuration is supported based on at least: a subcarrier spacing (SCS) of a primary synchronization signal (PSS) or a secondary synchronization signal (SSS); or the PBCH content. The WTRU may receive an indication for determining a location of a reduced capability PBCH. The WTRU may receive the reduced capacity PBCH at a location based on the indication. The WTRU may apply the reduced capability PBCH configuration.

Examples of reduced capability (RedCap) WTRU (e.g., a reduced capacity WTRU) are provided herein. In examples, a 5 MHz bandwidth reduced capability WTRU may be used. In examples, one or more of the following may be applied for reducing device complexity: reducing WTRU bandwidth to 5 MHz in FR1; or reducing WTRU peak data in FR1. WTRU bandwidth reduction to 5 MHz in FR1 may be used in combination with relaxed WTRU processing timeline(s) for at least one of a physical downlink shared channel (PDSCH), a physical uplink channel (PUSCH), or channel state information (CSI). In examples, a WTRU peak data rate in FR1 may include a restricted bandwidth for PDSCH and/or PUSCH. In examples, the WTRU peak data rate in FR1 may be used in combination with relaxed WTRU processing timeline(s) for at least one of PDSCH, PUSCH, or CSI. Operation in a bandwidth part (BWP) with or without a synchronization signal block (SSB) and with or without radio front end (RF) retuning may be considered. In examples herein, a reference to a reduced capability (RedCap) WTRU may be synonymous with a reduced capacity WTRU.

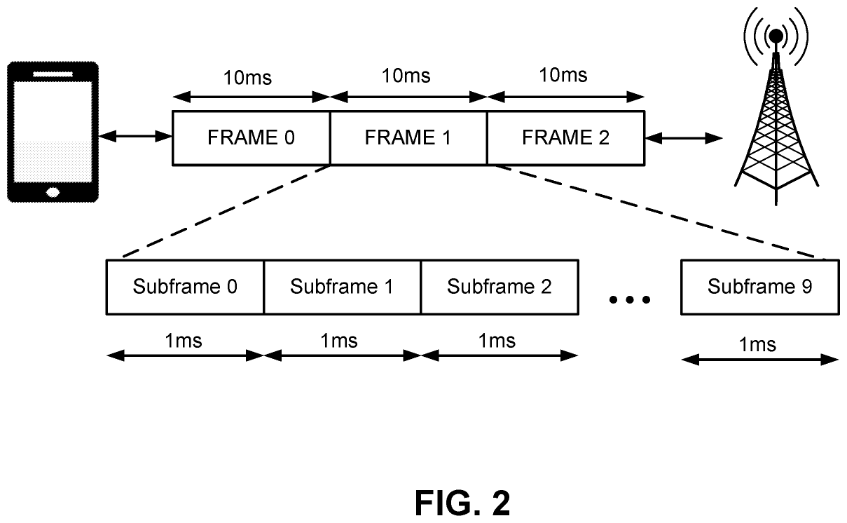

FIG. 2 illustrates an example configuration of frames and subframes. In examples, SCS may be 15 kHz. In examples, such as NR, SCS may be 15, 30, 60, 120, 240 kHz, etc. (e.g., depending on the numerology). DL and UL transmissions may be organized using frames of 10 ms duration. The frames (e.g., each frame) may be divided into two 5 ms half-frames and ten 1 ms subframes. Half-frame 0 may include subframes 0-4 and half-frame 1 may include subframes 5-9.

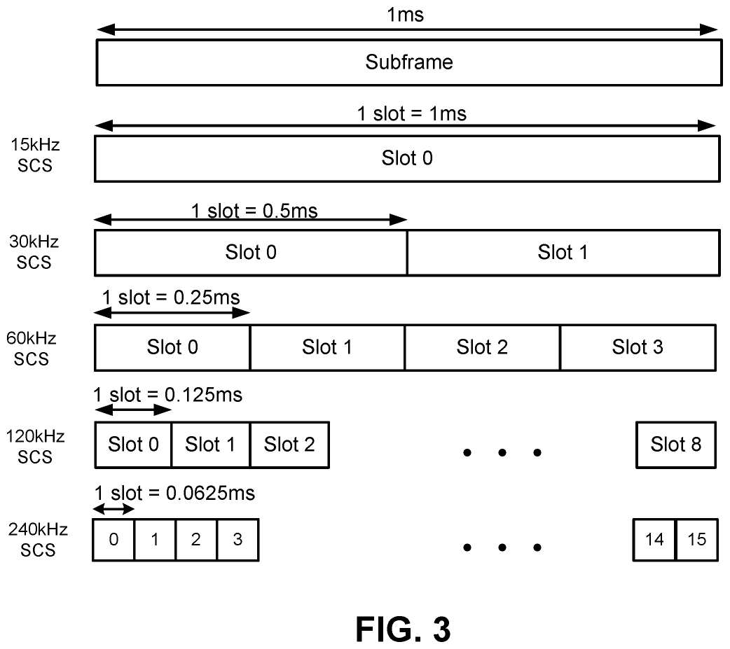

FIG. 3 illustrates an example configuration of slots. The size of a slot (e.g., and hence the number of slots in a subframe) may vary depending on the SCS. The slot length may become shorter as the SCS becomes wider. The number of symbols in a slot may not change with numerology or subcarrier spacing. In examples, the number of symbols may be 14 (for normal cyclic prefix) or 12 (for extended cyclic prefix).

A resource block may include 12 subcarriers in the frequency domain. In examples, the resource block bandwidth may be 180 KHz, but the bandwidths may vary depending on the SCS (e.g., in NR). Examples of resource block sizes are provided in Table 1 below:

TABLE 1
Resource block sizes

| | Resource block frequency | Resource block time |
|---|---|---|
| SCS | domain | domain |
| 15 kHz | 180 kHz (15 × 12) | 1 ms |
| 30 kHz | 360 kHz (30 × 12) | 0.5 ms |
| 60 kHz | 720 kHz (60 × 12) | 0.25 ms |
| 120 kHz | 1440 kHz (120 × 12) | 0.125 ms |
| 240 kHz | 2880 kHz (240 × 12) | 0.0625 ms |

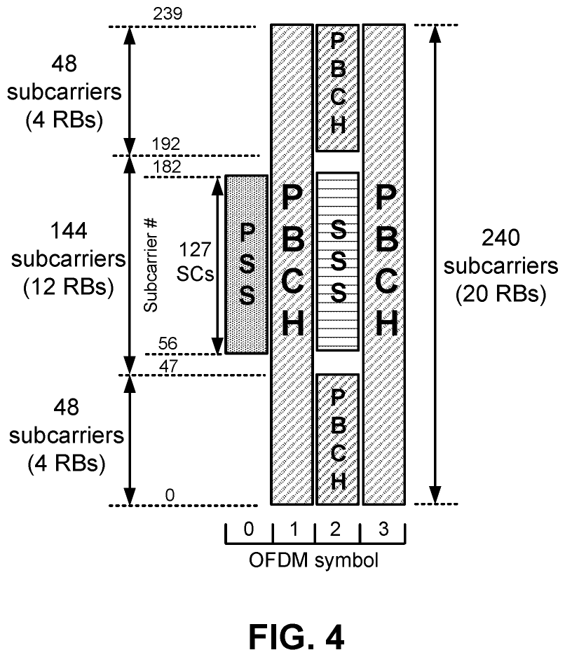

FIG. 4 illustrates an example of a SSB time-frequency structure. Examples of SSB resources are provided in Table 2 below:

TABLE 2
SSB resources

| | OFDM symbol | |
|---|---|---|
| | number ‘l’ | |
| Channel or | relative to the | Subcarrier number ‘k’ |
| Signal | start of an SSB | relative to the start of an SSB |
| PSS | 0 | 56, 57, . . . , 182 |
| SSS | 2 | 56, 57, . . . , 182 |
| Set to ‘0’ | 0 | 0, 1, . . . , 55, 183, 184, . . . , 239 |
| | 2 | 48, 49, . . . , 55, 183, 184, . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + v, 4 + v, 8 + v, . . . ,236 + v |
| PBCH | 2 | 0 + v, 4 + v, 8 + v, . . . ,236 + v |
| | | 192 + v, 196 + v, . . . ,236 + v |

Table 2 includes resources in an SSB for PSS, SSS, PBCH, and demodulation reference signal (DM-RS) for PBCH. The location of PBCH DM-RS may depend on the PCI (v=NIDcell mod 4) of the cell (e.g., PCI may already be determined by the WTRU using PSS/SSS). Table 2 may be represented in a resource grid structure (e.g., as shown in FIG. 4).

The SSB may span four symbols in the time domain and may span 240 contiguous subcarriers (20 RBs) in the frequency domain. As the SSB may occupy 20 RBs and there may be 12 subcarriers in each RB, there may be a total of 240 subcarriers. The bandwidth occupied by SSB=240 * subcarrier spacing. 15 kHz SCS leads to 240*15 KHz=3.6 MHz and 30 kHz SCS leads 240*30 KHz=7.2 MHz and so on. A higher SCS may be FR2.

The PSS/SSS may occupy 12 RBs. The 12 RBs may include unused subcarriers (e.g., unused subcarriers above and below). For example, PSS and SSS may use 127 subcarriers and there may be 8 unused subcarriers below and 9 unused subcarriers above. As such, for 15 kHz SCS, the PSS/SSS may occupy 144*15=2.16 MHz and for 30 kHz SCS, the PSS/SS may occupy 144*30=4.32 MHz.

The SSB structure may be general and may be defined for numerologies (e.g., all numerologies). For a half frame with SS/PBCH blocks, the first symbol indexes for candidate SS/PBCH blocks may be determined according to the SCS of SS/PBCH blocks by at least the following, where index 0 corresponds to the first symbol of the first slot in a half-frame: case A—15 kHz SCS: the first symbols of the candidate SS/PBCH blocks have indexes of {2,8}+14·n; case B—30 KHz SCS: the first symbols of the candidate SS/PBCH blocks have indexes {4,8, 16,20}+28·n (e.g., for carrier frequencies smaller than or equal to 3 GHz, n=0, for carrier frequencies within FR1 larger than 3 GHZ, n=0,1); case C—30 KHz SCS: the first symbols of the candidate SS/PBCH blocks have indexes {2,8}+14·n; case D—120 KHz SCS: the first symbols of the candidate SS/PBCH blocks have indexes {4,8,16,20}+28·n (e.g., for carrier frequencies within FR2, n=0,1,2,3,5,6,7,8,10,11,12,13,15,16,17,18); case E—240 KHz SCS: the first symbols of the candidate SS/PBCH blocks have indexes {8,12,16,20,32,36,40,44}+56·n (e.g., for carrier frequencies within FR2-1, n=0,1,2,3,5,6,7,8); case F—480 kHz SCS: the first symbols of the candidate SS/PBCH blocks have indexes {2,9}+14·n. (e.g., for carrier frequencies within FR2-2, n=0,1,2,3,4,5,6,7,8,9,10,11,12,13,14,15,16,17,18,19,20,21,22,23,24,25,26,27,28,29,30,31); or case G—960 KHz SCS: the first symbols of the candidate SS/PBCH blocks have indexes {2,9}+14·n (e.g., for carrier frequencies within FR2-2, n=0,1,2,3,4,5,6,7,8,9,10,11,12,13,14,15,16,17,18,19,20,21,22,23,24,25,26,27,28,29,30,31).

Regarding case A, for operation without shared spectrum channel access: n=0,1 for carrier frequencies smaller than or equal to 3 GHz and n=0, 1,2,3 for carrier frequencies within FR1 larger than 3 GHz. For operation with shared spectrum channel access, n=0,1,2,3,4. Regarding case C, for operation without shared spectrum channel access and for paired spectrum operation, n=0,1 for carrier frequencies smaller than or equal to 3 GHZ and n=0,1,2,3 for carrier frequencies within FR1 larger than 3 GHZ. For operation without shared spectrum channel access and for unpaired spectrum operation, n=0,1 for carrier frequencies smaller than 1.88 GHz and n=0, 1,2,3 for carrier frequencies within FR1 equal to or larger than 1.88 GHz. For operation with shared spectrum channel access, n=0,1,2,3,4,5,6,7,8,9.

If the SCS for SS/PBCH blocks is unknown, the applicable cases for a cell may depend on a frequency band (e.g., respective frequency band) (e.g., as shown in Table 3 below). For bands with two possible SCSs, the WTRU may (e.g., may need to) try both SCS hypothesis to detect the SSB. Table 3 is shown as follows:

TABLE 3
Applicable cases for a cell if SCS for SS/PBCH blocks is unknown

| | | | Range of GSCN |
|---|---|---|---|
| NR operating | SS Block | SS Block | (First-<Step |
| band | SCS | pattern¹ | size>-Last) |
| n1 | 15 kHz | Case A | 5279-<1>-5419 |
| n2 | 15 kHz | Case A | 4829-<1>-4969 |
| n3 | 15 kHz | Case A | 4517-<1>-4693 |
| n5 | 15 kHz | Case A | 2177-<1>-2230 |
| | 30 kHz | Case B | 2183-<1>-2224 |
| n7 | 15 kHz | Case A | 6554-<1>-6718 |
| n8 | 15 kHz | Case A | 2318-<1>-2395 |
| n12 | 15 kHz | Case A | 1828-<1>-1858 |
| n13 | 15 kHz | Case A | 1871-<1>-1885 |
| n14 | 15 kHz | Case A | 1901-<1>-1915 |
| n18 | 15 kHz | Case A | 2156-<1>-2182 |
| n20 | 15 kHz | Case A | 1982-<1>-2047 |
| n24 | 15 kHz | Case A | 3818-<1>-3892 |
| | 30 kHz | Case B | 3824-<1>-3886 |
| n25 | 15 kHz | Case A | 4829-<1>-4981 |
| n26 | 15 kHz | Case A | 2153-<1>-2230 |
| n28 | 15 kHz | Case A | 1901-<1>-2002 |
| n29 | 15 kHz | Case A | 1798-<1>-1813 |
| n30 | 15 kHz | Case A | 5879-<1>-5893 |
| n34 | 15 kHz | Case A | NOTE 5 |
| | 30 kHz | Case C | 5036-<1>-5050 |
| n38 | 15 kHz | Case A | NOTE 2 |
| | 30 kHz | Case C | 6437-<1>-6538 |
| n39 | 15 kHz | Case A | NOTE 6 |
| | 30 kHz | Case C | 4712-<1>-4789 |
| n40 | 30 kHz | Case C | 5762-<1>-5989 |
| n41 | 15 kHz | Case A | 6246-<3>-6717 |
| | 30 kHz | Case C | 6252-<3>-6714 |
| n463 | 30 kHz | Case C | 8993-<1>-9530 |
| n48 | 30 kHz | Case C | 7884-<1>-7982 |
| n50 | 30 kHz | Case C | 3590-<1>-3781 |
| n51 | 15 kHz | Case A | 3572-<1>-3574 |
| n53 | 15 kHz | Case A | 6215-<1>-6232 |
| n65 | 15 kHz | Case A | 5279-<1>-5494 |
| n66 | 15 kHz | Case A | 5279-<1>-5494 |
| | 30 kHz | Case B | 5285-<1>-5488 |
| n67 | 15 kHz | Case A | 1850-<1>-1888 |
| n70 | 15 kHz | Case A | 4993-<1>-5044 |
| n71 | 15 kHz | Case A | 1547-<1>-1624 |
| n74 | 15 kHz | Case A | 3692-<1>-3790 |
| n75 | 15 kHz | Case A | 3584-<1>-3787 |
| n76 | 15 kHz | Case A | 3572-<1>-3574 |
| n77 | 30 kHz | Case C | 7711-<1>-8329 |
| n78 | 30 kHz | Case C | 7711-<1>-8051 |
| n79 | 30 kHz | Case C | 8480-<16>-8880⁷ |
| | | | 8475-<1>-8884⁸ |
| n85 | 15 kHz | Case A | 1826-<1>-1858 |
| n90 | 15 kHz | Case A | 6246-<1>-6717 |
| | 30 kHz | Case C | 6252-<1>-6714 |
| n91 | 15 kHz | Case A | 3572-<1>-3574 |
| n92 | 15 kHz | Case A | 3584-<1>-3787 |
| n93 | 15 kHz | Case A | 3572-<1>-3574 |
| n94 | 15 kHz | Case A | 3584-<1>-3787 |
| n96⁴ | 30 kHz | Case C | 9531-<1>-10363 |

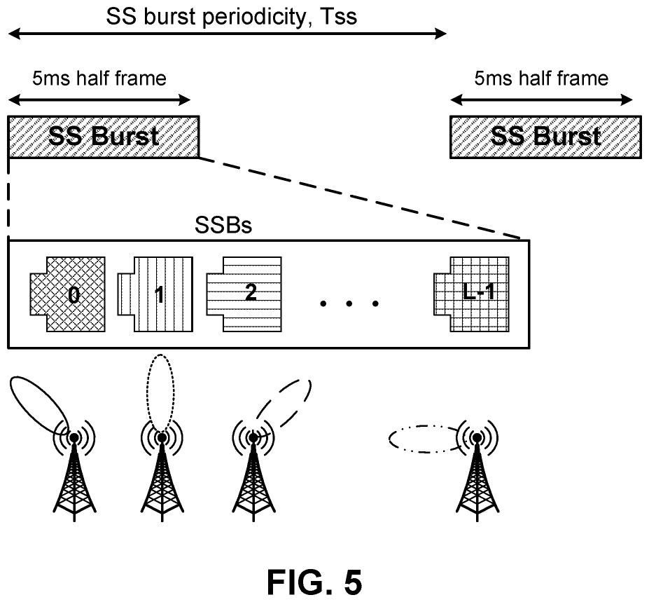

FIG. 5 illustrates an example of SS bursts and beam sweeping. Using beam sweeping (e.g., as shown in FIG. 5), the gNB may transmit (e.g., periodically transmit) SS bursts. The SS bursts may include multiple SSBs (e.g., according to the SS block patterns defined herein). The SSBs (e.g., each SSB) may be transmitted using a specific beam using a predefined beam direction and periodicity. An SSB may be transmitted with a periodicity of 5 ms, 10 ms, 20 ms, 40 ms, 80 ms or 160 ms. The WTRU may assume 20 ms for initial cell search and idle mode mobility.

Examples of synchronization signals are provided herein. The PSS and SSS may be used so that the WTRU can find the frame boundary and determine the physical cell identity. A PSS may include one of three 127-symbols m-sequences. A PSS may be allocated on the first symbol of each SSB, and on 127 subcarriers. A SSS may include one of 336 127-symbols gold sequences. A SSS may be allocated on the third symbol of each SSB, and on 127 subcarriers.

Cells (e.g., each cell) may be identified by a physical cell ID from 1008 IDs that may be arranged into 336 different groups. The physical cell ID may be calculated by:

$${N}_{ID}^{cell} = 3 {N}_{ID}^{( 1 )} + {N}_{ID}^{( 2 )}$$

where: N (1) ID=the cell ID group indicated by the SSS, range is from {0, 1 . . . 335} and N (2) ID=the cell ID sector indicated by the PSS, range is from {0, 1, 2}.

Features associated with PBCHs are provided herein. A PBCH may broadcast the MIB. The PBCH may include information to identify (e.g., necessary to identify) the candidate SSB within the SS burst. If determining (e.g., after determining) the cell ID from PSS/SSS, the WTRU may determine the two or three LSBs of the SSB index with a half-frame from the index of the DMRS transmitted in PBCH. The MSBs may be determined from the MIB contents. The MIB may (e.g., may also) indicate whether the SSB resides in the first or the second 5 ms half-frame of a 10 ms frame. If decoding (e.g., after decoding) the PBCH, the WTRU may know the sample timing within the full frame.

The WTRU may determine the system frame number (SFN) from PBCH content. For example, the SFN may be determined by obtaining the four LSBs used in channel coding of the PBCH by blind decode trials, each combination corresponding to a specific 4 LSBs, with one resulting in a successful decode, and the 6 MSBs may be provided in the decoded MIB. If decoding (e.g., after decoding) the PBCH, the WTRU may know the full SFN.

The PBCH DMRS and the SSS may be used to perform channel estimation. The PBCH DMRS and the SSS may (e.g., may also) be used to determine the reference signal received power (RSRP) of the candidate SSB. Based on this beam measurement, the WTRU may determine and may select the best candidate beam.

The MIB may include the PDCCH configuration. The PDCCH configuration may include the CORESET0 and search space 0 configuration (e.g., such that the WTRU can receive SIB1 and the remaining system information). SIB and the remaining system information may include the remaining information the WTRU may need in order to access the cell, for example, the random access channel configuration.

Table 4 shows example information provided by a PBCH below:

TABLE 4
PBCH/MIB contents

| | Number of Bits | | | |
|---|---|---|---|---|
| | | | Carried | Carried by PBCH |
| Information/field | Total | | by MIB | (excluding MIB contents) |
| System Frame Number (SFN) | 10 | | 6 | 4 |
| Sub Carrier Spacing (for SIB1, | 1 | | 1 | 0 |
| Initial access Msg-2/4, paging, SI- | | | | |
| messages) | | | | |
| SSB Subcarrier Offset | FR1 | _{——}_{——} 5 | 4 | 1 |
| | FR2 | _{——}_{——} 4 | | 0 |
| dmrs-TypeA-Position | 1 | | 1 | 0 |
| PDCCH Config for SIB1 | 8 | | 8 | 0 |
| Cell Barring Information flag | 1 | | 1 | 0 |
| Intra-Frequency Reselection | 1 | | 1 | 0 |
| allowed/not allowed flag | | | | |
| SSB Index | FR1 | _{——}_{——} 0 | 0 | 0* |
| | FR2 | _{——}_{——} .3 | | 3* |
| half-frame bit | 1 | | 0 | 1 |
| Spare bits | 1 | | 1 | 0 |
| Reserved bits | FR1 | _{——}_{——} 2 | 0 | 2 |
| | FR2 | _{——}_{——} 0 | | 0 |
| BCCH-BCH-MessageType | 1 | | 1 | 0 |
| indication | | | | |

| | | | |
|---|---|---|---|
| CRC bits | 24 | 0 | 24 |
| Total Number of bits | 56 (FR1 or FR2) | 24 | 32 (FR1 or FR2) |

*4 additional (LSB) bits are implicitly carried by PBCH scrambling sequence.

Cell search features are provided herein. During the cell search (e.g., initial cell search), the WTRU may scan the frequency band using the sync raster according to the frequency band the search is being performed on. The SCS and sync raster may depend on the frequency band. The synchronization raster may indicate the frequency positions of the SSBs that can be used by the WTRU for system acquisition.

Applying synchronization algorithms using the PSS and SSS, the WTRU may estimate and correct the time and frequency offsets. The WTRU may obtain N (2) ID from PSS and may (e.g., may then) obtain N (1) ID from SSS to determine the cell ID. With the cell ID, the WTRU may (e.g., may then) perform a PBCH DMRS search in order to perform channel and noise estimation. The WTRU may (e.g., may then) demodulate and decode the PBCH to extract information (e.g., the remaining information) that may be needed to proceed to PDCCH monitoring for SIB1 reception. If the WTRU receives SIB1, then the WTRU may have the common channel configurations that may be necessary to access the cell. The WTRU may proceed with a random access transmission in order to request on-demand system information or to establish a radio resource control (RRC) connection in order to register and/or initiate a call.

The PDCCH may carry scheduling assignments for PDSCH and PUSCH and other control information in DCI. DCI may include a transport format, a resource allocation, hybrid automatic repeat request (HARQ) information related to DL-SCH, UL-SCH, and a physical control channel (PCH). A PCH may be transmitted on an aggregation of one or several consecutive control channel elements (CCEs), where a CCE may correspond to 9 resource element groups. The number of resource element groups not assigned to PCFICH or PHICH may be REG N. The CCEs available in the system may be numbered from 0 and N_CCE-1, where N_CCE=floor (N_REG/9). The PDCCH may support multiple formats. A PDCCH may include n consecutive CCEs and may start (e.g., only start) on a CCE fulfilling imod n=0, where i is the CCE number. The information element pdcch-ConfigSIB1 transmitted in the MIB may provide an index to the CORESET0 configuration used for the PDCCH scheduling SIB1.

If the SCS is more than 15 kHz, then the SSB bandwidth may be wider than that supported by the WTRU. The WTRU may not be able to read the PBCH and MIB. The 30 KHz SCS may be supported by channel bandwidths no less than 10 MHz (e.g., 10 MHz channel bandwidth may be used as an example herein).

A 30 KHz SCS may have the SSB arrangement (e.g., entire SSB arrangement) around the central frequency Fc, meaning that the central 240 sub-carriers, that is 20RBs, 10RBs towards the low part and 10RBs towards the upper side of the channel. In terms of frequency domain, that is 3.6 MHz on each side of the Fc for a total of 7.2 MHz. The PSS and SSS sequences may occupy a narrower bandwidth than the overall SSB in the frequency domain, being restricted to the central 127 sub-carriers, that is the central 3.78 MHz of a 10 MHz channel. A 5 MHz capable WTRU may be able to decode PSS and SSS for a 30 KHz SCS, but there may be no capability to decode PBCH to read the MIB (e.g., under these circumstances). A MIB and possibly SIB1 may have to be coded differently so that these reduced capability WTRUs are able to receive the MIB and SIB1 within their supported bandwidth, and in a way that the legacy PBCH is not impacted. The reduced capability WTRU detecting a 30 KHz SCS may know (e.g., may automatically know) that it cannot decode the regular legacy MIB, but the reduced capability WTRU has already acquired the slot and symbol level synchronization.

If the SCS is 15 kHz, even though it may be decoded, the MIB may not have enough spare bits to indicate more than a presence of 5 MHz WTRU specific CORESET0. The MIB bits may be reinterpreted such that the CORESET #0 and search space #0 indexes in the existing PDCCH-Config have an alternative meaning for a reduced capability WTRU. A limited number of fixed CORESET #0/search space #0 configurations may be defined, but this may limit configuration flexibility. Even if the SCS is 15 kHz and MIB can be decoded, the amount of configuration information (e.g., CORESET0 configuration) may be extremely limited. It may (e.g., may still) be necessary for a MIB and SIB1 to use different coding to avoid impacting legacy PBCH and SIB1 configurations.

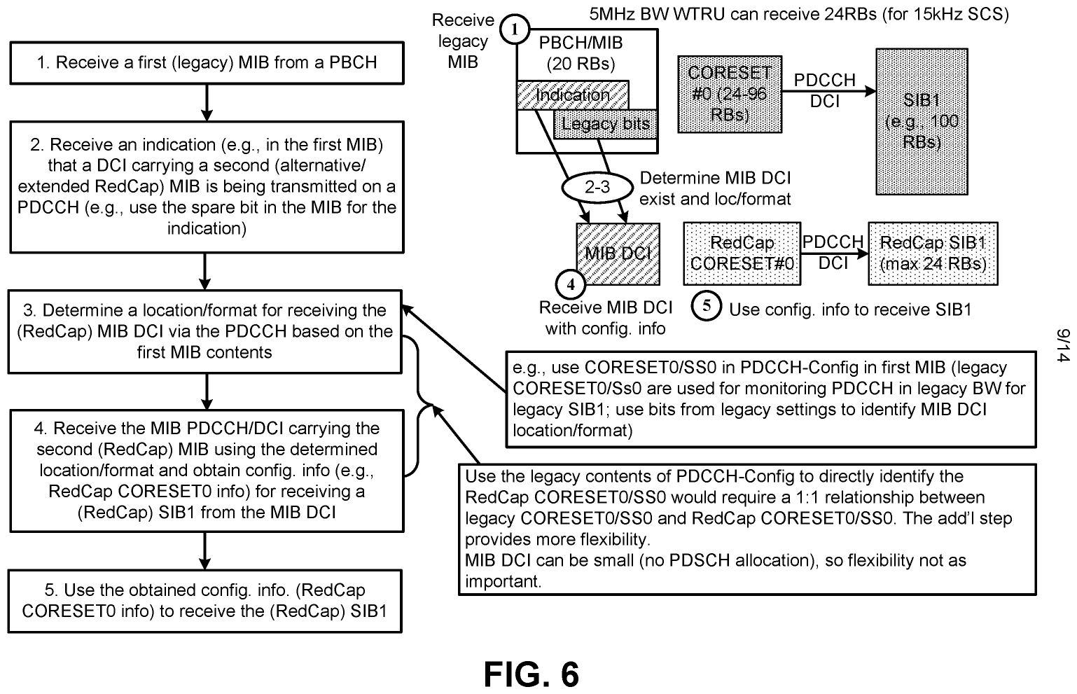

FIG. 6 illustrates an example of a WTRU (e.g., reduced capability WTRU) that may detect an unsupported SSB/PBCH. As shown in FIG. 6, the WTRU (e.g., reduced capability WTRU) may receive a first MIB (e.g., legacy MIB) via a PBCH. As shown in FIG. 6, the WTRU (e.g., reduced capability WTRU) may receive an indication (e.g., in the first MIB) for determining (e.g., any of) a first location and format for receiving a second MIB (e.g., reduced capability MIB) via a reduced capability specific PBCH or PBCH extension (e.g., reduced capability-PBCH or R-PBCH). As shown in FIG. 6, the WTRU (e.g., the reduced capability WTRU) may determine the first location for receiving the second MIB based on contents of the first MIB (e.g., configuration information for a first CORESET) in the indication and/or based on the WTRU being a reduced capability WTRU.

As shown in FIG. 6, the WTRU (e.g., reduced capability WTRU) may receive the second MIB associated with a reduced capability-PBCH using the determined location and format. The WTRU (e.g., the reduced capability WTRU) may apply the configuration included in (e.g., the contents of the second MIB included in) the reduced capability SSB (e.g., to be used instead of the existing PBCH) to determine (e.g., any of) a second location or format associated with receiving a SIB (e.g., a PDCCH DCI associated with receiving the SIB). In examples, rather than introducing a physical layer channel (e.g., reduced capability PBCH) or extension to the existing PBCH or SSB, the information (e.g., the second MIB) may be conveyed using a PDCCH (e.g., instead of in a SSB), either by scheduling a message (e.g., a MIB or a new message type) on a PDSCH, or conveying the information (e.g., the second MIB) in a DCI type on a PDCCH (e.g., in a PDCCH DCI). As shown in FIG. 6, the second MIB may be received via the PDCCH DCI. As shown in FIG. 6, the second location or format associated with receiving a SIB (e.g., a PDCCH DCI associated with receiving the SIB) may be determined based on contents of the second MIB (e.g., configuration information for a second CORESET). As shown in FIG. 6, the SIB may be received based on the second location or format. A reference to a reduced capability-PBCH may apply to any of the examples described herein (e.g., a new PBCH type, an extension to the existing PBCH, or a transmission of a PDCCH in a DCI or a new message type scheduled on a PDSCH).

During cell search, the WTRU may check the possible cases supported by the band. For example, in band n5, both 15 kHz and 30 kHz SCS may be used, and CaseA or Case B SSB pattern, as shown in Table 5 below:

TABLE 5

| | | | Range of GSCN |
|---|---|---|---|
| | SS Block | SS Block | (First-< Step |
| NR operating band | SCS | pattern¹ | size>-Last) |
| n5 | 15 kHz | Case A | 2177-<1>-2230 |
| | 30 kHz | Case B | 2183-<1>-2224 |

The WTRU may have to attempt to decode both options to determine which is used. If 15 kHz SCS is detected, then the 5 MHz BW WTRU may decode PBCH and MIB. However, as there are very limited spare bits (e.g., 1 bit in MIB, and 2 bits in PBCH for FR1, 0 bits in PBCH for FR2), it may not be possible to flexibly provide a separate configuration for CORESET0/SIB1 reception.

If 30 KHz SCS is detected, the PSS may (e.g., may still) be detected even if PBCH is transmitted over a wider bandwidth than the WTRU supports. The WTRU may attempt different SCS options according to the band being searched, and if 30 KHz SCS is detected, then the WTRU may know (e.g., at this point) that it cannot receive the associated PBCH due to the PBCH being transmitted using a wider bandwidth than the WTRU supports.

The detection of unsupported PBCH may use at least the following two examples, depending on the SCS in use: detection may occur using PSS/SCC if the 30 KHz SCS is used; or detection may occur using the PBCH if the 15 kHz SCS is used.

During detection, the WTRU may (e.g., may also receive) an indication which is used to determine the location of the reduced capability-PBCH. If the location of the reduced capability-PBCH is determined, the WTRU may proceed to demodulate and decode the reduced capability-PBCH. The reduced capability-PBCH may provide a configuration for CORESET0 and search space 0, which the reduced capability WTRU may apply to continue the initial access procedure.

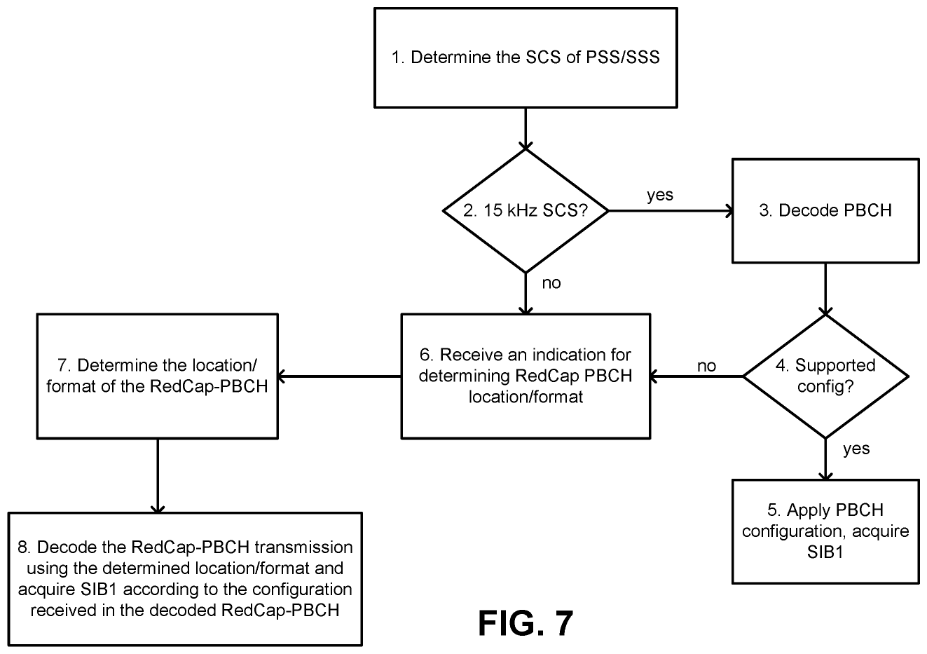

FIG. 7 illustrates an example of reduced capability-PBCH detection and reception. (1)-(5) in FIG. 7 illustrate the detection of the unsupported configuration. In (1), the WTRU may use (e.g., use existing) synchronization procedures and algorithms to determine the SCS and obtain time and frequency synchronization (e.g., as described herein).

If the SCS is greater than 15 kHz, for example a SCS of 30 kHz in a 10 MHz bandwidth, then the WTRU may know (e.g., at this point) that the PBCH configuration is unsupported. The WTRU may know that the PBCH configuration is unsupported because the WTRU may be unable to decode the PBCH due to it being transmitted using a wider bandwidth than the WTRU supports (e.g., and may proceed directly to (6) in FIG. 7).

If the WTRU determines in (1) and (2) that the SCS is 15 kHz, then the WTRU may proceed to decode the PBCH in (3). Based on the information received in the PBCH (e.g., in the MIB), the WTRU may determine in (4) whether or not the configuration provided in PBCH is supported. In examples, the PDCCH configuration may correspond to one using less than 5 MHz bandwidth, for example, a CORESET0 which uses 24 RBs, in which the WTRU may apply the configuration and proceed to receive the legacy SIB1 in (5).

If the WTRU detects that the configuration provided in PBCH is not supported (e.g., if the WTRU is a reduced capability WTRU, the WTRU may not support the configuration, for example, the WTRU may not be capable of receiving or using the configured number of RBs), the WTRU may proceed to (6). There may be a limited scope for information (e.g., additional information) to be provided by the existing PBCH due to limited spare bits. Some configuration information (e.g., additional configuration information) may (e.g., may need to) be provided in a separate PBCH or PBCH extension. Detection of an unsupported configuration may be based on unsupported subcarrierSpacingCommon or unsupported PDCCH-Config (e.g., PDCCH-Config provides a CORESET #0 configuration which uses a bandwidth greater than 5 MHz). Detection of an unsupported configuration may be based on the currently spare MIB bit being set to 1, or spare PBCH payload being set to one or more predefined values defined to provide an indication for a reduced capability WTRU to receive the R-PBCH.

(6) in FIG. 7 illustrates the WTRU receiving an indication for determining a reduced capability-PBCH location. The indication for determining the R-PBCH location and/or format in (6) may include of one or more of the following: if the WTRU detects SCS greater than 15 kHz (e.g., a 30 KHz SCS) or if the WTRU detects SCS of 15 kHz and an unsupported configuration in PBCH, then the WTRU may (e.g., may further) attempt to receive a reduced capability-PBCH using a predefined location and format; the location/format may be determined using all or part of the cell ID determined from the PSS and SSS; the location/format may depend on the frequency band; the location/format may depend on the SSB pattern found; the location/format may depend on the detected SCS; certain PSS and/or SSS and/or DMRS sequences may correspond to different behavior; the location/format may be determined using one or more orthogonal cover codes applied on PSS/SSS; or if the SCS is 15 kHz, the location/format may be determined using some or all of the content of the PBCH.

Regarding the WTRU that may attempt to receive a reduced capability-PBCH using a predefined location and format, the indication may be formed of the unsupported configuration and detection of the presence of a reduced capability-PBCH using the predefined location and format.

Regarding the location/format that may be determined using all or part of the cell ID determined from the PSS and SSS, the WTRU may calculate a time and/or frequency offset using some of the SFN (e.g., one or more of the LSBs) or it may use the SFN as an index to a table of predefined configurations.

Regarding the location/format that may depend on the frequency band, a time/frequency offset may be at least partly band specific and may be calculated using a specified relation or may be indicated in a table of predefined configurations.

Regarding the location/format that may depend on the SSB pattern found, a number of SSB patterns may be defined, which may be applicable depending on the band in use as well as the SCS. The patterns (e.g., each pattern) may be updated to include the location of a reduced capability-PBCH, or patterns (e.g., new patterns) may be defined which the WTRU may use depending on the existing pattens.

Regarding the location/format that may depend on the detected SCS, the location and format may be predefined and may depend on the SCS.

Regarding certain PSS and/or SSS and/or DMRS sequences that may correspond to different behavior, some sequences may be reserved/defined which correspond to enabling whether to execute (7)-(8) in FIG. 7. This may not mean that the sequences cannot be used for legacy operation, but it may imply a restriction on the network planning such that reduced capability WTRUs may (e.g., may only) be supported if using particular sequences. Some sequences may provide information (e.g., additional information) on how to find and decode a PBCH. In examples, some sequences may correspond to a configuration index or an index used in a calculation determining a time and/or frequency offset.

Regarding the location/format that may be determined using one or more orthogonal cover codes applied on PSS/SSS, certain codes may indicate a value to be applied if calculating the location or format of reduced capability-PBCH or determining the table index if looking up the configuration. These codes may be advantageously applied to the existing PSS/SSS (e.g., without impacting the legacy WTRUs).

Regarding the location/format that may be determined using some or all of the content of the PBCH if the SCS is 15 kHz SCS, the content of the PBCH may include at least the following: the CORESET #0 index; the search space #0 index; the DMRS type A position; the common SCS; the spare bit setting; all or part of the SFN; or whether the SSB resides in the first or second half frame.

Regarding the CORESET #0 index, depending on the index of the CORESET #0 which may define the configuration for PDCCH scheduling SIB1, the same index may be used to determine the configuration (e.g., location and format) of the reduced capability-PBCH.

Regarding the search space #0 index, (e.g., similar to the CORESET #0 index) this may be re-used to indicate (e.g., also indicate) an index for reduced capability-PBCH configuration.

Regarding the DMRS type A position, the value of this indication (e.g., existing indication) may be used to determine the reduced-PBCH configuration.

Regarding the common SCS, the value of this indication (e.g., existing indication) may be used to determine the reduced capability-PBCH configuration.

Regarding the spare bit setting, the spare bit may be used to indicate the presence of the reduced capability-PBCH, or it may toggle between two configurations.

Regarding all or part of the SFN, the index or the time/frequency offset may depend on some of the SFN LSBs.

Regarding whether the SSB resides in the first or second half frame, this may be indicated in PBCH. The half frame used may (e.g., may also) indicate the half frame to be used for reduced capability-PBCH. In examples, the PBCH and reduced capability-PBCH may be in first half frames (e.g., alternative half frames) or in second half frames (e.g., the same half frames). In examples, the MIB spare bit may indicate whether reduced capability-PBCH is in the second half frame (e.g., same half frame) or the first half frame (e.g., alternative half frame) compared to the PBCH.

In examples, determining the reduced capability-PBCH of neighbor cells may include (e.g., may only include) (6)-(8) of FIG. 7. If a WTRU has performed the initial cell search and has acquired the PBCH and SIB1 of an initial cell, the currently used cell may provide (e.g., explicitly provide) an indication including information related to neighboring cells. For a WTRU in RRC_IDLE or RRC_INACTIVE, the indication including the information may be part of a neighbor cell list broadcast in system information. The indication may be provided per cell, per carrier, per band, per PLMN, or may be globally applicable to neighbor cells (e.g., all neighbor cells). For a WTRU in RRC_CONNECTED, the indication may be provided as part of a measurement configuration. The indication may provide a way for the WTRU to determine (e.g., directly determine) the reduced capability-PBCH location for neighbor cells, which may allow the WTRU to skip (1)-(4) of FIG. 7 if the WTRU is performing normal mobility procedures (e.g., cell reselection, measurements, handover, etc.) after the initial cell search.

(7)-(8) of FIG. 7 illustrate a WTRU (e.g., a reduced capability WTRU) determining a reduced capability-PBCH location and format and receiving a configuration in the decoded reduced capability-PBCH (e.g., determine a location or format for receiving a second MIB via a PDCCH DCI). If an indication (e.g., within a first MIB) has been received (e.g., as described by examples herein), the WTRU may use that indication (e.g., within the first MIB) to determine the reduced capability-PBCH (e.g., determine the location and format for receiving the second MIB via the PDCCH DCI) based on contents of the first MIB (e.g., configuration information for a first CORESET). In examples, a relationship, such as a time/frequency offset, may be defined. The time/frequency offset may be calculated using at least the indicated value in (6). The time offset may be a number of symbols from the start of a half-frame or from the end of the existing PBCH. The number of symbols may be indicated using the value provided in the received indication.

In examples, multiple predefined configurations may be defined, while the value provided in the received indication may be an index or used to determine an index to the list of configurations. The list of configurations may (e.g., may also) be dependent on the band, SSB pattern, SCS, etc. The index may be calculated using a first group of information. The list which the index refers to may be determined using a second group of information. In examples, the index may be determined using the CORESET #index signaled in a MIB or using part of the cell ID, while the list may depend on the band or the SSB pattern.

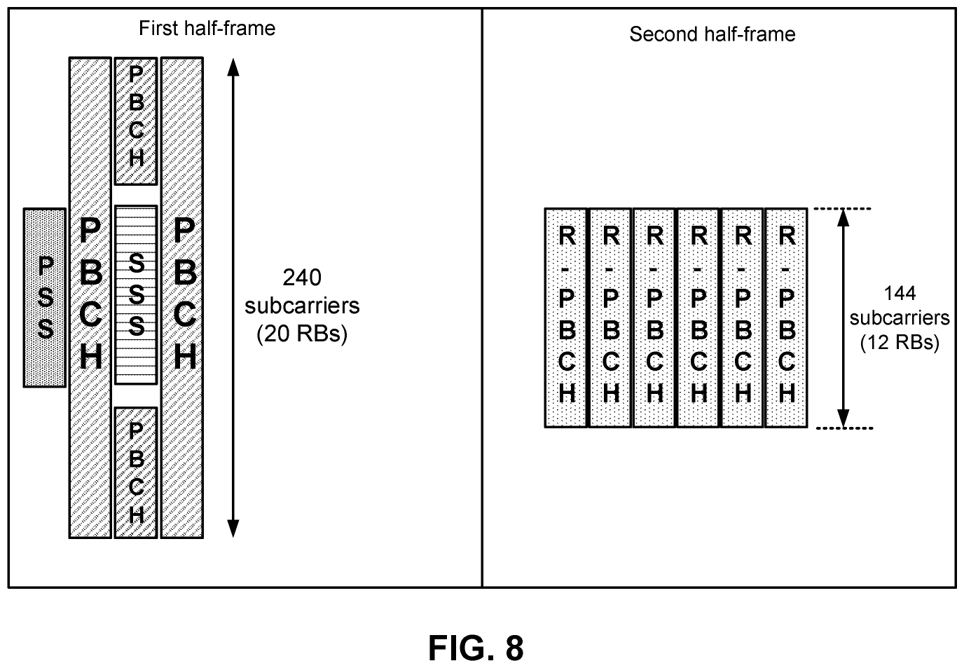

FIG. 8 illustrates an example of a reduced bandwidth, reduced capability-PBCH in the other half-frame (e.g., compared to the legacy PBCH). A specific time offset relative to the SSB pattern may be specified for a spectrum region for a channel (e.g., 10 MHz channel), where the RedCap specific MIB may be transmitted using a different format in frequency and time domain that may allow for the full PBCH acquisition (e.g., as shown in FIG. 8).

The reduced capability WTRU may be capable of slot/symbol synchronization using the PSS/SSS (e.g., in the legacy SSB). In examples, a reduced capability MIB position may be in the second 5 ms half-frame of the 10 ms radio frame if the legacy SSB resides in the first 5 ms half-frame. In examples, a reduced capability MIB position may be in the first half-frame if the legacy SSB resides in the second half-frame (e.g., the WTRU may receive PSS/SSS in the second half-frame of a first frame, then the reduced capability-PBCH in a first half-frame of a second frame). The reduced capability MIB may (e.g., may require) about 4 MHz in the frequency domain and six symbols in the time domain if a MIB with the same amount of content as the regular one is required. The starting symbol for the reduced capability-PBCH may be predefined according to one or more potential patterns. The starting symbol for the reduced capability-PBCH may be determined according to the indication received in (6) of FIG. 7.

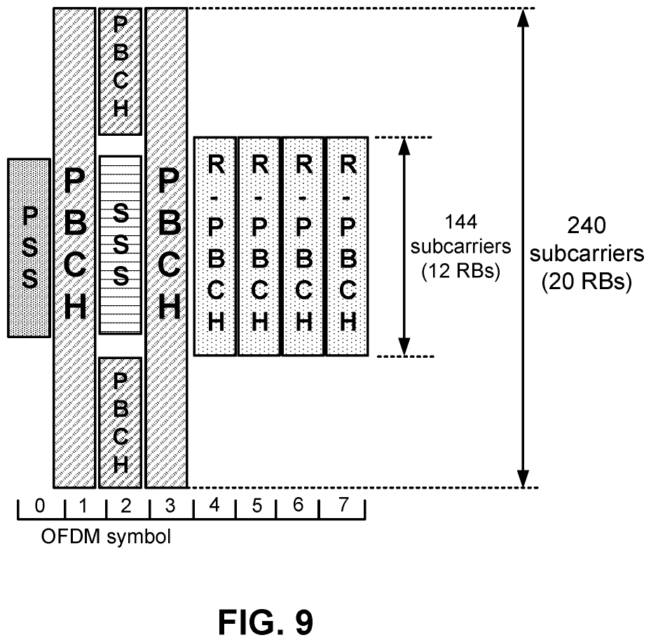

FIG. 9 illustrates a reduced bandwidth, reduced capability-PBCH in the same half-frame as the legacy PBCH. The reduced capability-PBCH may use a time offset. The time offset may be determined based on the received indication, which may result in the legacy PBCH and the reduced capability-PBCH being transmitted in the same half-frame (e.g., as shown in FIG. 9).

The reduced capability-PBCH may be transmitted in a symbol (e.g., the next consecutive symbol) after the legacy PBCH (then the offset would be 0), or it may be transmitted after a gap following the legacy PBCH. The network may not be required to and may choose not to transmit the legacy PBCH in a SSB location (e.g., in every SSB location) within a burst. The network may transmit the reduced capability-PBCH in one or more positions corresponding to the SSB burst pattern (e.g., instead of a legacy PBCH).

The SCS used for the legacy PBCH and the reduced capability-PBCH may be the same (e.g., as shown in FIGS. 7 and 8), but the reduced capability-PBCH may use a different number of subcarriers. The reduced capability-PBCH may use a different subcarrier spacing and may reside in another BWP. There may (e.g., may also) be a frequency offset defined, such that the reduced capability-PBCH may not reside in the central part of the band. It may be desirable to transmit a reduced capability-PBCH, which may include a PSS/SSS (e.g., to improve the synchronization on a frequency which is offset from the center of the band).

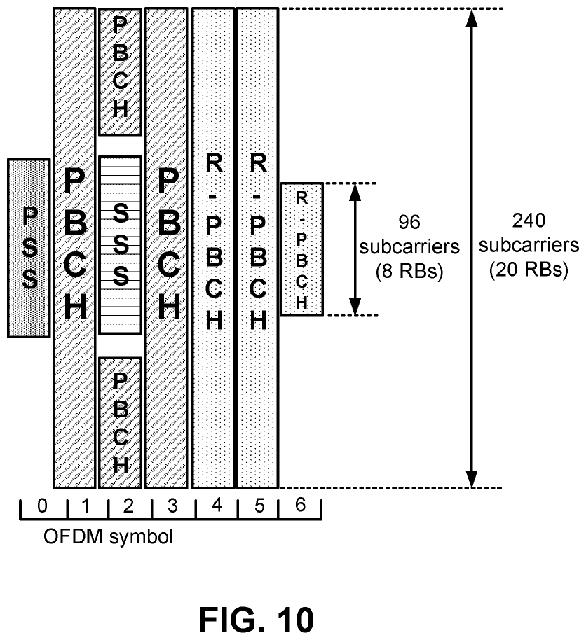

FIG. 10 illustrates an example of a reduced capability-PBCH with the same bandwidth as a legacy PBCH. If a 15 kHz SCS is used for the legacy PBCH but the legacy PBCH includes an unsupported configuration, then the reduced capability-PBCH may be transmitted using the same bandwidth in different symbols of either the same or another half-frame and may use a specific time or frequency offset as explained herein.

The WTRU may detect an invalid configuration in the legacy PBCH (e.g., if the WTRU is a reduced capability WTRU, the WTRU may not support the configuration, for example, the WTRU may not be capable of receiving or using the configured number of RBs) and may receive another configuration from the reduced capability-PBCH (e.g., configuration information for a second CORESET or reduced capability CORESET). The reduced capability-PBCH may include an entire MIB (e.g., a second MIB), or it may provide the information (e.g., only the information) which is different, such as the CORESET #0 ID (e.g., only the CORESET #0 ID). The indication (e.g., within the first MIB) received in (6) of FIG. 7 may determine the second MIB encoding format (e.g., may indicate at least one of the following options: whole MIB-same as legacy; whole-MIB-reduced capability specific encoding; or only delta part of MIB). The indication (e.g., within the first MIB) may point to multiple potential options. The WTRU may (e.g., may have to) trial the options (e.g., each option) until the WTRU is able to receive the reduced capability-PBCH (e.g., similar to how the WTRU may trial different SCS for synchronization and different SSB patterns according to the band).

One or more SSB patterns specific to the 5 MHz WTRU may be defined. PBCH/SSB locations may be defined. Some patterns may be enabling co-existence between legacy 30 KHz SCS SSB and 15 kHz SCS SSB. Other patterns may be 15 kHz only or 30 kHz only. The reduced capability-PBCH may be transmitted less frequently than the legacy PBCH using a particular SSB pattern. The indication may be used to determine the periodicity. The indication may redirect the reduced capability WTRU to another cell or carrier entirely (e.g., which may be reduced capability specific).

The same PBCH structure may be reused (e.g., completely reused). The configuration of the same PBCH structure being reused may allow for 5 MHz (e.g., 15 kHz SCS) to be used. In examples, legacy WTRUs may be prevented from receiving or decoding the PBCH if the same PBCH structure as the legacy WTRU is re-used, such as redefining a MIB content/ASN.1 definition (e.g., have MIB-type2 pointing to a different type of CORESET0 (e.g., a second CORESET or reduced capability CORESET) or providing different information). The MIB (e.g., second MIB) may not be decodable by a legacy WTRU. The MIB (e.g., second MIB) may fail SSB decoding by use of a CRC mask to cause legacy WTRU decoding to fail. ICellBarred IE interpretation may be reversed for a reduced capability WTRU (e.g., “barred” may be interpreted as “notBarred” by a reduced capability WTRU while “barred” may be interpreted as “barred” by a regular WTRU, likewise for “notBarred” case).

Examples of using a PDCCH are provided herein. A second MIB associated with the reduced capability-PBCH may be provided using a PDCCH, for example, using a DCI type (e.g., a PDCCH DCI) which may include similar information as carried (e.g., currently carried) on the PBCH (e.g., the CORESET #0 configuration, the SFN, etc.). The indication (e.g., within the first MIB) may be used to determine the first CORESET configuration information used for transmitting this DCI information (e.g., the PDCCH DCI information). A reduced capability-specific CORESET (e.g., a second CORESET) may advantageously reuse the existing PDCCH physical channel. The second CORESET may be smaller than the first CORESET. The reduced capability specific CORESET (e.g., second CORESET) may be received and may reuse the existing PDCCH physical channel (e.g., after the WTRU receives a PSS/SSS (and if the SCS is 15 kHz, receiving the PBCH) and before receiving using the CORESET #0 itself), which may provide a greater amount of flexibility as to the location and configuration of the reduced capability PDCCH compared to using a PBCH.

The indication described in (6) of FIG. 7 may be an index to a predefined CORESET configuration (e.g., a first CORESET configuration, similar to the CORESET #0 index). The predefined CORESET configuration (e.g., the first CORESET configuration) may be used to transmit a DCI (e.g., a PDCCH or standalone DCI) including information which replaces the PBCH information. If the SCS is 15 kHz, the DCI (e.g., the PDCCH or standalone DCI) may replace or may indicate the difference between PBCH information and reduced capability specific PBCH information. If the SCS is 30 kHz, the WTRU may operate without PBCH and instead rely on the information transmitted by the reduced capability CORESET (e.g., second CORESET, received before CORESET #0 and after PSS/SSS).

The reduced capability DCI may be scrambled using a new radio network identifier (RNTI) (e.g., reducedcapabilityRNTI) which may advantageously allow information to be transmitted in a PDCCH used (e.g., also used) for scheduling other types of WTRU or for other purposes. The reduced capability DCI may provide a CORESET #0 and search space 0 configuration. The reduced capability DCI may provide the SFN (e.g., since the RedCap WTRU may be unable to receive a PBCH to receive the SFN).

Examples of reduced capability specific RSs are provided herein. Reduced capability WTRUs detecting 30 KHz SCS may not be able to detect their MIB in a cell that does not support reduced capability WTRUs. The cell search time may be (e.g., may need to be) reduced for these WTRUs (e.g., avoid the WTRU performing a MIB detection process for too long), in case the cell does not support reduced capability WTRUs.

A reduced capability linked reference signal (RS) may be interleaved with reduced capability MIB symbols that may reduce the risk of having a reduced capability WTRU staying in a MIB decoding trial for too long. The reduced capability linked RS may be called the reduced capability-RS. The linked RS may be a channel state information reference signal (CSI-RS) that may have the same bandwidth as the regular PSS, SSS signals. The linked RS (e.g., the CSI-RS) may maintain the same measurement accuracy for the cell. The CSI-RS may be part of a range or collection of CSI-RS sequences that may be specified for this kind of operation. The RS may be a PBCH DMRS (e.g., new PBCH DMRS) or DMRS positions which may be defined differently for the reduced capability WTRU based on the cell ID. Orthogonal cover codes may be used to detect a reduced capability specific PBCH. The WTRU may cycle through the possible RS sequences before attempting reduced capability-MIB decoding.

The RS sequence may be a CSI-RS sequence that may be scrambled with a specific reduced capability orthogonal cover code. The CSI-RS sequence may have a PCI relation or mapping that may help randomize the DL interference for the reduced capability-RS cell identification and MIB decoding. For the time domain, the reduced capability-RS sequence may be repeated (e.g., repeated twice) and have different codes or cover codes applied (e.g., like the regular MIB).

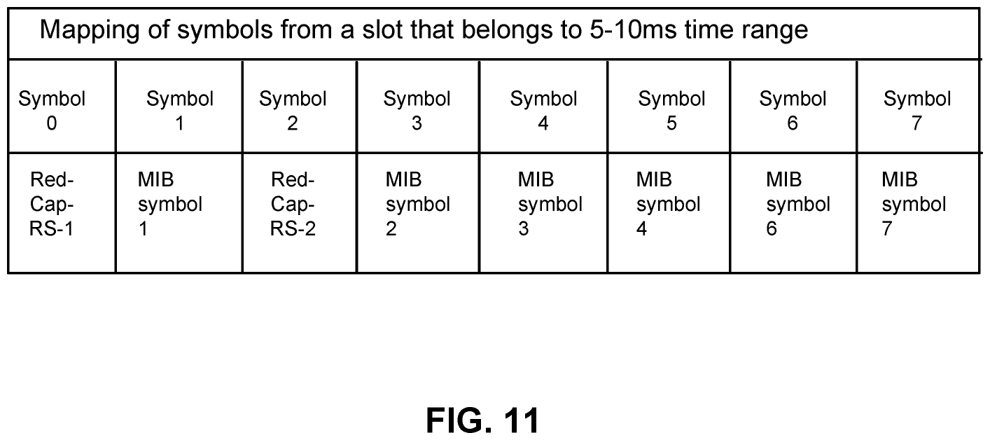

FIG. 11 illustrates an example of reduced capability-RS symbol positioned in a reduced capability-PBCH. For example, if the MIB requires six symbols, a configuration (e.g., combination) such as that shown in FIG. 11 may be applied.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

The invention claimed is:

1-20. (canceled)

21. A wireless transmit/receive unit (WTRU), comprising:
a processor configured to:
receive, via a physical broadcast channel (PBCH), a first master information block (MIB);
determine, based on contents of the first MIB, one or more of a first location associated with reception of a second MIB or a first format associated with the reception of the second MIB;
receive, using one or more of the first location or the first format, the second MIB, wherein the second MIB is received via a physical downlink control channel (PDCCH) downlink control information (DCI);
determine, based on contents of the second MIB, one or more of a second location associated with reception of a system information block (SIB) or a second format associated with reception of the SIB; and
receive the SIB based on the second location or the second format.

22. The WTRU of claim 21, wherein the contents the first MIB include first configuration information associated with a first control resource set (CORESET), and wherein the first configuration information is used to determine the first location or the first format.

23. The WTRU of claim 22, wherein the contents of the second MIB include second configuration information associated with a second CORESET, and wherein the second configuration information is used to determine the second location for reception of a PDCCH DCI associated with the reception of the SIB or the second format for the reception of the PDCCH DCI associated with the reception of the SIB.

24. The WTRU of claim 23, wherein the second CORESET is smaller than the first CORESET.

25. The WTRU of claim 21, wherein the first MIB includes an indication that the second MIB is being transmitted.

26. The WTRU of claim 21, wherein the WTRU is a reduced capability WTRU.

27. The WTRU of claim 26, wherein determining the first location or the first format is further based on the WTRU being the reduced capability WTRU.

28. A method associated with a wireless transmit/receive unit (WTRU), the method comprising:
receiving, via a physical broadcast channel (PBCH), a first master information block (MIB);
determining, based on contents of the first MIB, one or more of a first location associated with reception of a second MIB or a first format associated with the reception of the second MIB;
receiving, using one or more of the first location or the first format, the second MIB, wherein the second MIB is received via a physical downlink control channel (PDCCH) downlink control information (DCI);
determining, based on contents of the second MIB, one or more of a second location associated with reception of a system information block (SIB) or a second format associated with reception of the SIB; and
receiving the SIB based on the second location or the second format.

29. The method of claim 28, wherein the contents the first MIB include first configuration information associated with a first control resource set (CORESET), and wherein the first configuration information is used to determine the first location or the first format.

30. The method of claim 29, wherein the contents of the second MIB include second configuration information associated with a second CORESET, and wherein the second configuration information is used to determine the second location for reception of a PDCCH DCI associated with the reception of the SIB or the second format for the reception of the PDCCH DCI associated with the reception of the SIB.

31. The method of claim 30, wherein the second CORESET is smaller than the first CORESET.

32. The method of claim 28, wherein the first MIB includes an indication that the second MIB is being transmitted.

33. The method of claim 28, wherein the WTRU is a reduced capability WTRU.

34. The method of claim 33, wherein determining the first location or the first format is further based on the WTRU being the reduced capability WTRU.

35. A wireless transmit/receive unit (WTRU), comprising:
a processor configured to:
receive a first master information block (MIB), wherein the first MIB includes first configuration information associated with a first control resource set (CORESET);
determine, based on the first configuration information associated with the first CORESET, one or more of a first location associated with reception of a second MIB or a first format associated with the reception of the second MIB;
receive, using one or more of the first location or the first format, the second MIB, wherein the second MIB includes second configuration information associated with a second CORESET;
determine, based on the second configuration information associated with the second CORESET, one or more of a second location associated with reception of a system information block (SIB) or a second format associated with the reception of the SIB; and
receive the SIB based on the second location or the second format.

36. The WTRU of claim 35, wherein the second MIB is received via a physical downlink control channel (PDCCH) downlink control information (DCI).

37. The WTRU of claim 36, wherein the second configuration information associated with the second CORESET is used to determine the second location for receiving a PDCCH DCI associated with the reception of the SIB or the second format for receiving a PDCCH DCI associated with the reception of the SIB, and wherein the second CORESET is smaller than the first CORESET.

38. The WTRU of claim 35, wherein the first MIB is received via a physical broadcast channel (PBCH).

39. The WTRU of claim 35, wherein the first MIB includes an indication that the second MIB is being transmitted.

40. The WTRU of claim 35, wherein the WTRU is a reduced capability WTRU, and wherein determining the first location or the first format is further based on the WTRU being the reduced capability WTRU.
